(19) United States
(12) Patent Application Publication
(10) Pub. No.: US 2012/0036457 A1
(43) Pub. Date: Feb. 9, 2012

(54) INTEGRATED DEVELOPMENT ENVIRONMENT FOR RAPID APPLICATION DEVELOPMENT

(75) Inventors: Geoffrey Shelkey Perlman, Austin, TX (US); Thomas Robert McGrath, Rocky Hill, CT (US)

(73) Assignee: REAL Software, Inc., Austin, TX (US)

(21) Appl. No.: 13/204,147

(22) Filed: Aug. 5, 2011

Related U.S. Application Data
(60) Provisional application No. 61/371,996, filed on Aug. 9, 2010.

(51) Int. Cl. G06F 3/00

(52) U.S. Cl. 715/760

(57) ABSTRACT

A method for developing and executing a web application to be used in a data processing system. The method includes instantiating an object in a memory, the object associated with a first web page of the web application. The method also includes displaying the first web page to an end user. The method further includes receiving at least one update to the first web page from a web browser of the end user. The method still further includes storing the at least one update to the first web page in the object. The method also includes displaying a second web page to the end user. The method further includes re-displaying the first web page based on the at least one update to the object.

### CROSS-REFERENCE TO RELATED APPLICATION(S) AND CLAIM OF PRIORITY

The present application is related to U.S. Provisional Patent Application No. 61/371,996, filed Aug. 9, 2010, entitled “APPLICATION DELIVERY SYSTEMS”. Provisional Patent Application No. 61/371,996 is assigned to the assignee of the present application and is hereby incorporated by reference into the present application as if fully set forth herein. The present application hereby claims priority under 35 U.S.C. §119(e) to U.S. Provisional Patent Application No. 61/371,996.

### TECHNICAL FIELD OF THE INVENTION

The present application relates generally to application and software development and, more specifically, to an integrated development environment for rapid application development.

### BACKGROUND OF THE INVENTION

In order to create web content, software, and other applications, developers may use an integrated development environment (IDE) (also known as integrated design environment, integrated debugging environment or interactive development environment). An IDE is a software application that provides a comprehensive framework to developers and programmers for software development. A typical IDE includes a source code editor, a compiler and/or an interpreter, build automation tools, and a debugger.

Deploying applications to an end user over the Internet presents many challenges to a developer. First, there is no consistent standard to which computers must adhere when interfacing with the Internet. For example, many differences exist between various Internet browsers (or “web browsers”) in the way that the browsers interpret scripting languages, commands, and the like, to retrieve, generate, and display web content to a user. Second, the operating system (or “platform”) for each computer capable of accessing the Internet varies between computers. For example, some computers run on a Windows platform. Others run on a Mac or Linux platform. Typically, application developers have had to possess knowledge of the differences between the platforms and browsers to develop applications that are compatible across many platforms and browsers.

In order to overcome these limitations, improved systems and methods are needed that may be used to deploy an application to an end user.

### SUMMARY OF THE INVENTION

A method for developing and executing a web application to be used in a data processing system is provided. The method includes instantiating an object in a memory, the object associated with a first web page of the web application. The method also includes displaying the first web page to an end user. The method further includes receiving at least one update to the first web page from a web browser of the end user. The method still further includes storing the at least one update to the first web page in the object. The method also includes displaying a second web page to the end user. The method further includes re-displaying the first web page based on the at least one update to the object.

A data processing system configured for developing and executing a web application and comprising a processor and an accessible memory is also provided. The data processing system is configured to instantiate an object in a memory, the object associated with a first web page of the web application. The data processing system is also configured to display the first web page to an end user. The data processing system is further configured to receive at least one update to the first web page from a web browser of the end user. The data processing system is still further configured to store the at least one update to the first web page in the object. The data processing system is also configured to display a second web page to the end user. The data processing system is further configured to re-display the first web page based on the at least one update to the object.

A computer program product for developing and executing a web application is also provided. The computer program product includes a tangible machine-readable medium encoded with computer-executable instructions that when executed cause a data processing system to perform instantiating an object in a memory, the object associated with a first web page of the web application. The data processing system also performs displaying the first web page to an end user. The data processing system further performs receiving at least one update to the first web page from a web browser of the end user. The data processing system still further performs storing the at least one update to the first web page in the object. The data processing system also performs displaying a second web page to the end user. The data processing system further performs re-displaying the first web page based on the at least one update to the object.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an integrated development environment (IDE) according to an embodiment of the present disclosure;

FIG. 2A illustrates communication flow for a CGI-deployed web application according to an embodiment of the present disclosure;

FIG. 2B illustrates communication flow for a stand-alone web application according to an embodiment of the present disclosure; and

FIG. 3 illustrates a system configured to host an IDE, according to an embodiment the present disclosure.

### DETAILED DESCRIPTION OF THE INVENTION

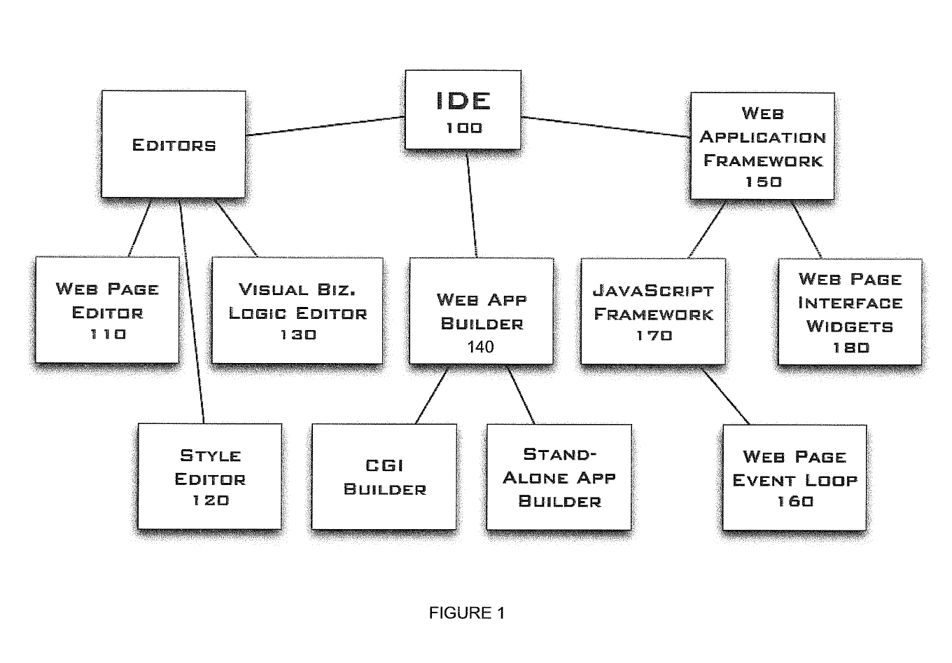

FIGS. 1 through 3, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged integrated development environment.

The invention will now be described with respect to various embodiments. The following description provides specific details for a thorough understanding of, and enabling description for, these embodiments of the invention. However, one skilled in the art will understand that the invention may be practiced without these details. In other instances, well known structures and functions have not been shown or described in detail to avoid unnecessarily obscuring the description of the embodiments of the invention.

The following documents and standards descriptions are hereby incorporated into the present disclosure as if fully set forth herein:

http://docs.realsoftware.com/.

To address the above-discussed deficiencies of the prior art, the present disclosure provides an integrated development environment (IDE) (also referred to as an “application development framework” or simply “framework”) that greatly simplifies for a developer the task of developing and deploying web-based and desktop-based applications across a variety of platforms.

FIG. 1 is a block diagram illustrating an integrated development environment according to an embodiment of the present disclosure. Using the IDE 100, a developer can create a user interface of a web application using a plurality of visual, drag-and-drop editors included in the IDE 100. As shown in FIG. 1, the IDE 100 includes a plurality of editors, including a web page editor 110, a style editor 120, and a visual business logic editor 130. The IDE 100 also includes a web application builder 140 and a web application framework 150.

The web page editor 110 allows the developer to build a web page by dragging user interface controls (e.g., fields, buttons, lists, and the like) from a list of available controls to the web page, and position the controls by dragging. The developer can then double-click on a control to add programming logic to specific events of that control using an object-oriented language included in the IDE 100. The style editor 120 allows the developer to edit and use styles that control the appearance and behavior of each control. The style editor 120 also permits the developer to define new styles that can be added to a project.

From the perspective of an end user, a web application created with the IDE 100 appears and behaves similar to other web applications. For example, to access the application, the end user provides a URL (uniform resource locator) in a web browser, like the end user would do with any other web page. However, in a web application created and deployed with the IDE 100, the web pages of the application are not driven by a web server loading pages stored on the server, but by the web application dynamically generating the pages and passing the pages to the web server, which will send the pages to the client (i.e., the browser of the end user).

Managing Web Page State

Using the IDE 100, for each web page the application produces, the application maintains persistent objects that contain the current state of the web page, including its entire user interface. This means that the developer does not have to write code to manage the state of web pages as the end user moves from one page to another. Instead, this state is managed for the developer automatically.

Typically, when a developer writes a web application in PHP (or a similar scripting language), the developer is responsible for keeping track of checkbox statuses, values in fields, and so forth, for when an end user moves from one web page to another. For example, consider a typical web application that includes a number of web pages. If the end user checks a checkbox on a first page and then moves to a second web page, the first web page and its checkbox are erased, deleted, or otherwise no longer tracked in memory. Thus, the developer must include code that stores the current state of the checkbox on the first page and code to return the checkbox to that state when the end user returns to the first page.

In contrast to typical development environments, the IDE 100 manages these functions automatically for the developer. The developer designs the web application using the IDE 100, but the developer does not need to include program code to store and manage status information for each element in each web page. Each web page is maintained in a manner analogous to an open window in a desktop GUI environment. More specifically, the instance of each web page persists in the memory of the server. The server instantiates an object per user for each accessed web page, and the object represents the current state of that page.

When a web page is requested of a web application developed using the IDE 100, the page description is first loaded from the binary application into the object in memory which represents the page. The web application framework 150 then automatically generates the HTML code for displaying the web page from the object and sends the HTML code to the web browser. The end user may then make changes to the page by updating one or more user-updatable controls (e.g., filling in a text box, clicking a button or check box, selecting from a drop-down list, and so forth). If any of the controls the end user has manipulated is associated with code, the state of the controls the user has changed is sent to the server, and the object that represents that page for that user session is updated.

Later, when the code executes to instruct the web page object in memory on the server to re-render the page, the web application framework 150 re-creates the page from the data in the object that maintains the persistent state of the controls on that page and sends the page to the client web browser.

Web Application Builder Platform

A typical web application may use several Common Gateway Interfaces (CGIs) and/or FastCGIs to provide the functionality of the application. Each CGI or FastCGI typically performs one function, such as processing a credit card. Most CGIs or FastCGIs are written in a language like Perl. Each Perl script is actual Perl source code and provides one small function such as presenting and processing log-in information or displaying search results. Therefore, in addition to a potentially large number of HTML, JavaScript, and CSS files, a traditional web application might also have many Perl script files, each providing a very specific function and communicating with the web server via a CGI or FastCGI.

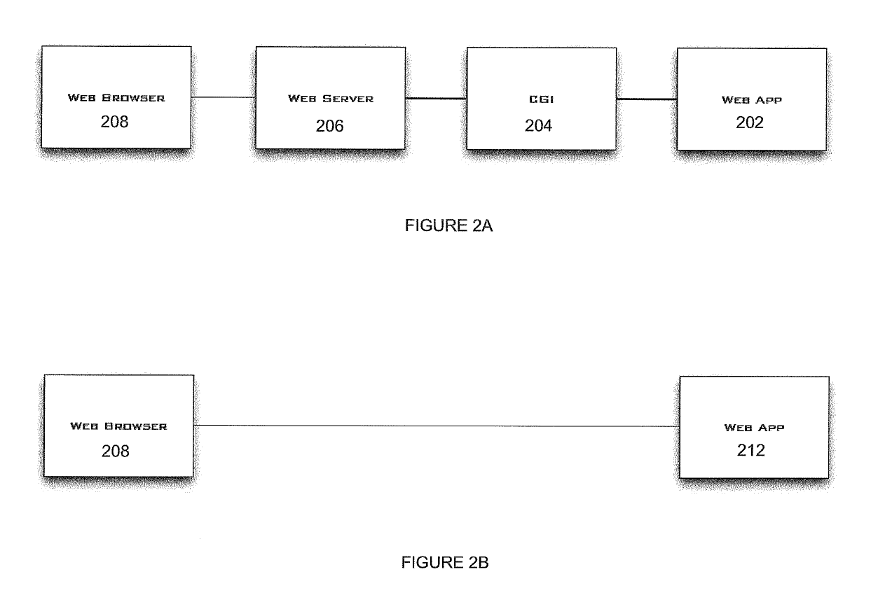

In contrast, the IDE 100 compiles the entire user interface and all the business logic (i.e., programming code) into a single binary application. For example, in one aspect of operation, the IDE 100, using the web application builder 140, builds a web application and a CGI. The CGI can be executed as a regular CGI or a FastCGI. The CGI and the web application communicate with each other and with the web server. The application and CGI manage the communication (via a custom protocol) with the web server for the developer. This is illustrated in FIG. 2A. In FIG. 2A, a web application 202 and a CGI 204 are generated by the web application builder 140. The web application 202 and the CGI 204 communicate with a web browser 208 via a web server 206.

In another aspect of operation, the IDE 100, using the web application builder 140, builds a stand-alone web application without a CGI. This is illustrated in FIG. 2B. In FIG. 2B, the stand-alone web application 212 communicates directly with the web browser 208. The stand-alone web application 212 does not require communication through a CGI or web server.

In either aspect of operation, the developer does not need to add any additional programming for the communication with the web server, and, as a result, the developer's entire web application acts as one integrated unit.

Event Mapping

Event mapping is a method of mapping events from the developer's abstract concept of a page and its user interface controls to the actual web page and its interface controls. Only the events that have been implemented by the developer are mapped. The result is that when an end user takes an action that results in an event (e.g., clicking on a button or typing a key in a text field) on a control where that event has an implementation (i.e., code written by the developer to execute when that event occurs), the JavaScript framework 170 included in IDE 100 sends a message to the web application on the server indicating that this event has taken place on this control. The web application on the server then executes the code for that event. If the executed code changes the user interface of the page that the end user is browsing, the web application automatically re-renders the affected controls and elements of the page, then sends the updated page information (HTML, CSS, and JavaScript) to the end user's browser.

Binary Subfiles for Security

In a typical web application, files that need to be sent to the browser (such as graphics) are stored on the server in their regular format. The web server is then responsible for sending these files to the browser when they are requested. In contrast, a web application developed using the IDE 100 compiles files at runtime, and then the web application sends the files to the browser when requested. Thus, the files are not saved to a disk. This method provides additional security in that the packaged files cannot be removed, edited, or replaced easily, since the files are only generated by the web application at runtime. This makes hacking or defacing a web application far more difficult.

Web Page Localization

When a browser connects to a web application, the browser provides the web application with the preferred written language of the end user as well as the name of the operating system the browser is running upon. The IDE 100 stores localized text strings in the binary web application. The text strings can be in multiple different languages. When the web page is generated, the web application swaps in the localized strings, based on the language and operating system provided by the browser.

Single Development Language

The IDE 100 allows the developer to use a single language to build the entire web application. The IDE 100 also abstracts the developer from the concepts of client and server. Rather than requiring a developer to consider, and develop code for, the concept of an application that executes on a client machine and communicates with a server, the IDE 100 abstracts the developer completely from this consideration. Using the IDE 100, the developer creates the application and writes code as if the entire application is running on a single machine. The web application framework 150 included in the IDE 100 manages all the communications between the client and the server.

Client-Side, Dynamic Page Rendering

Typical web applications include code and scripts for each web page that must be sent to the client machine as a whole each time that web page is accessed. This results in a large amount of network traffic and unnecessary overhead. In accordance with embodiments of the present disclosure, the IDE 100 transmits a relatively small amount of data describing the web page and business logic to the client machine. Then the client-side JavaScript framework 170, included in the IDE 100 and residing on the client machine, renders the final web page from the transmitted data. This is more efficient than having to send an entire pre-rendered page to the client.

Platform Independent Web Application Building

The IDE 100 is platform-independent. The IDE 100 is configured to execute on Mac OS X, Windows, and Linux. In addition, the IDE 100 builds web applications that are also platform-independent. Using the IDE 100, a developer can develop web applications for Mac OS X, Windows, or Linux, regardless of the platform that the IDE 100 is executed on. For example, using the IDE 100 on a Mac OS X platform, a developer can develop web applications for Windows or Linux.

Using the IDE 100, a developer is abstracted from most platform details. For example, the developer does not need to possess advanced knowledge of Mac OS X, Windows, or Linux. More specifically, the developer does not need to possess advanced knowledge of the platform of the machine that the end user is browsing from, and also does not need to possess advanced knowledge of the server that the web application is deployed on. In order to deploy an application on a platform, the developer selects a platform, actuates the “build” button (or performs another similar action), and the application is customized for that platform.

The developer also does not need to have advanced knowledge of different languages (e.g., HTML, CSS, JavaScript, PHP, and the like). The developer is also abstracted from detailed differences between browsers (e.g., Windows Internet Explorer, Google Chrome, Mozilla Firefox, and the like). This is possible because the web content is built at run-time. When the framework sends the page to the browser, the framework notes the platform details and dynamically builds the page at run time. So, if the framework determines that a page is being sent to an Internet Explorer browser, and the framework knows that Internet Explorer does not recognize a particular function in HTML, the framework can dynamically change the HTML (without input from the developer) to be fully compatible with Internet Explorer. These changes are made before the output is sent to the browser.

Mobile Platform Interfaces

In accordance with the present disclosure, the IDE 100 includes methods to build mobile platform-specific applications and user interfaces that share business logic across the different platforms. For example, using the IDE 100, a developer can develop mobile applications for two or more of Apple iOS, BlackBerry OS, Symbian, Windows Phone, and any other suitable mobile platform. A mobile application running on Apple iOS can share business logic with a mobile application ruining on BlackBerry OS.

Visual Business Logic for Web Pages

In accordance with the present disclosure, the IDE 100 includes the visual business logic editor 130, which provides a visual interface to create business logic. The editor 130 allows the developer to create rules that will validate or invalidate, and/or format the data presented in controls on the web page that is presented to the end user. The visual business logic editor 130 uses user interface controls to create the business logic rather than the developer entering programming code. For example, a web page may include a date field that prompts the end user to enter a date. The developer may use the visual business logic editor 130 to create one or more business logic rules that indicate that only dates within a certain range are valid. In some embodiments, the created business logic will be translated into client-side JavaScript.

Client-Side, Web Page Event Loop

In accordance with the present disclosure, the web application framework 150 includes the web page event loop 160. The web page event loop 160 is a client-side method to determine new or additional business logic that needs to be performed at a repeating interval.

Web Browser-Independent Web Page Interface Widgets

In accordance with the present disclosure, the web application framework 150 includes a set of user interface widgets 180 that abstract the developer from browser-specific and platform-specific details. In a typical development environment, a developer would have to write code to make web page user interface widgets work properly in different web browsers. The user interface widgets 180 abstract the developer from these details. The web application framework 150 of the IDE 100 provides web page user interface controls that are designed to work properly across different web browsers.

License Key Scheme

In accordance with the present disclosure, the IDE 100 provides improved systems and methods to create a licensing schema. In one embodiment, a first step is to generate an XML file containing the license key, user name, and a 4096-bit digital signature. The 4096-bit digital signature offers a very high level of protection against unauthorized use. For example, a 512-bit signature can be factored (the process of determining the private key) in about four weeks. The ability to factor a 1024-bit signature is not yet possible, but is perhaps a few years away. However, the ability to factor a 4096-bit signature is likely many years from being a possibility, or it may never happen.

Next, 256 hex characters (0-9, A-F) are randomly selected and stored in an array. The first 32 characters are replaced with the hexed MD5 of the user's purchase e-mail address. The replacement characters function similar to a password for the file.

Using a list of twenty pre-shared rules, a binary password is generated using numbers based on this array. For each product that uses this system, the twenty pre-shared rules would be different. There may be hundreds of pre-shared rules from which the twenty pre-shared rules are randomly chosen. For example, one pre-shared rule might indicate that the first bit in the password might be the number of “A”s after the second “B”. Another pre-shared rule might indicate the numeric position of the last “F” character in the array of 256 hex characters. The pre-shared rules are pre-determined by both the generator of the license key and the IDE/client.

After creation of the password, the signature that uses the password is encrypted. Then, the 256-character array and the hexed version of the signature are stored as one blob (Binary Large OBject) into the XML code. A parser will notice that the first 256 characters are not part of the encrypted data. However, a human will not be able to decipher the signature because the characters appear to be a random character string.

Next, the entire XML package is encrypted using a key that is approximately forty or more characters long. The encryption key is a pre-shared key that both the license key generator and the IDE 100 know in advance. The key is also not stored in a variable, so a debugger will not identify the key either. This first layer of encryption will be difficult to break. The second layer will be very difficult to break. Even if someone succeeds in breaking the encryption, the person will need to figure out how to re-encrypt, which will be significantly more difficult. Furthermore, even if a person can do all of this, that person will still require a “hacked” copy of the IDE to use a custom file. Since the signature is in the XML, the IDE 100 does not need to contact a server to verify authenticity.

This licensing scheme is resistant to everything except a hacked binary. Furthermore, using code signing method, the IDE 100 can actually detect if the binary has been modified, and act accordingly to avoid unauthorized access. For example, the IDE 100 may build a “crippled” application.

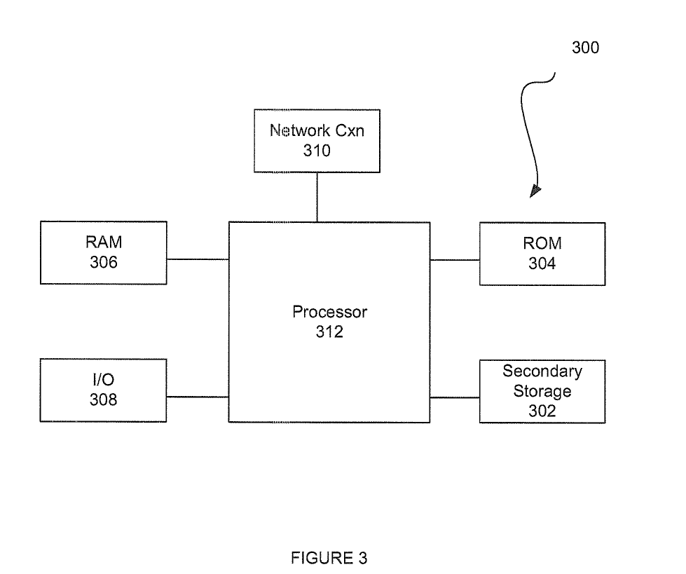

FIG. 3 is a block diagram illustrating a system configured to host an IDE, such as IDE 100, according to an embodiment of the present disclosure. As shown in FIG. 3, a general-purpose computer 300 (or web server) is provided with sufficient processing power, memory resources, and network throughput capability to handle the necessary workload placed upon it. The general-purpose computer 300 includes a processor 312 (which may be referred to as a central processor unit or CPU) that is in communication with memory devices including secondary storage 302, read only memory (ROM) 304, random access memory (RAM) 306, input/output (I/O) 308 devices, and network connectivity devices 310. The processor may be implemented as one or more CPU chips.

The secondary storage 302 is typically comprised of one or more disk drives or tape drives and is used for non-volatile storage of data and as an over-flow data storage device if the RAM 306 is not large enough to hold all working data. The secondary storage 302 may be used to store programs that are loaded into the RAM 306 when such programs are selected for execution. The ROM 304 is used to store instructions and perhaps data that are read during program execution. The ROM 304 is a non-volatile memory device that typically has a small memory capacity relative to the larger memory capacity of secondary storage. The RAM 306 is used to store volatile data and perhaps to store instructions. Access to both ROM 304 and RAM 306 is typically faster than to the secondary storage 302.

The I/O 308 devices may include printers, video monitors, liquid crystal displays (LCDs), touch screen displays, keyboards, keypads, switches, dials, mice, track balls, voice recognizers, card readers, paper tape readers, or other well-known input devices. The network connectivity devices 310 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards such as code division multiple access (CDMA) and/or global system for mobile communications (GSM) radio transceiver cards, and other well-known network devices. The network connectivity devices 310 may enable the processor 312 to communicate with an Internet or one or more intranets. With such a network connection, the processor 312 may receive information from the network, or may output information to the network in the course of performing the above-described method steps. Such information, which is often represented as a sequence of instructions to be executed using the processor 312, may be received from and outputted to the network, for example, in the form of a computer data signal embodied in a carrier wave.

Such information, which may include data or instructions to be executed using the processor 312, for example, may be received from or transmitted to the network, for example, in the form of a computer data baseband signal or signal embodied in a carrier wave. The baseband signal or signal embodied in the carrier wave generated by the network connectivity devices 310 may propagate in or on the surface of electrical conductors, in coaxial cables, in waveguides, in optical media, for example optical fiber, or in the air or free space. The information contained in the baseband signal or signal embedded in the carrier wave may be ordered according to different sequences, as may be desirable for either processing or generating the information or transmitting or receiving the information. The baseband signal or signal embedded in the carrier wave, or other types of signals currently used or hereafter developed, referred to herein as the transmission medium, may be generated according to several methods well known to one skilled in the art.

The processor 312 executes instructions, codes, computer programs, scripts that it accesses from hard disk, floppy disk, optical disk (these various disk based systems may all be considered secondary storage 302), ROM 304, RAM 306, or the network connectivity devices 310.

Also, techniques, systems, subsystems and methods described and illustrated in the various embodiments as discrete or separate may be combined or integrated with other systems, modules, techniques, or methods without departing from the scope of the present disclosure. Other products shown or discussed as directly coupled or communicating with each other may be coupled through some interface or device, such that the products may no longer be considered directly coupled to each other but may still be indirectly coupled and in communication, whether electrically, mechanically, or otherwise with one another. Other examples of changes, substitutions, and alterations are ascertainable by one skilled in the art and could be made without departing from the spirit and scope disclosed herein.

It should be understood that although an exemplary implementation of one embodiment of the present disclosure is illustrated above, the present system may be implemented using any number of techniques, whether currently known or in existence. The present disclosure should in no way be limited to the exemplary implementations, drawings, and techniques illustrated above, including the exemplary design and implementation illustrated and described herein, but may be modified within the scope of the appended claims along with their full scope of equivalents.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method for developing and executing a web application to be used in a data processing system, the method comprising:
instantiating an object in a memory, the object associated with a first web page of the web application;
displaying the first web page to an end user;
receiving at least one update to the first web page from a web browser of the end user;
storing the at least one update to the first web page in the object;
displaying a second web page to the end user; and
re-displaying the first web page based on the at least one update to the object.

2. The method of claim 1, wherein the update to the first web page persists in the object while the second web page is displayed to the end user.

3. The method of claim 1, further comprising:
receiving a design of the web application from a developer, wherein the design does not include program code to manage the at least one update to the first web page in the object.

4. The method of claim 1, wherein displaying the first web page to the end user comprises:
automatically generating HTML code associated with displaying the first web page; and
sending the HTML code to the web browser of the end user.

5. The method of claim 4, wherein the HTML code is automatically generated when the first web page is requested to be displayed by the web browser of the end user.

6. The method of claim 1, wherein receiving at least one update to the first web page comprises:
receiving a change to a: least one user-updatable control.

7. The method of claim 1, wherein the web application is developed and executed using an integrated development environment.

8. A data processing system configured for developing and executing a web application and comprising a processor and an accessible memory, the data processing system configured to:
instantiate an object in the memory, the object associated with a first web page of the web application;
display the first web page to an end user;
receive at least one update to the first web page from a web browser of the end user;
store the at least one update to the first web page in the object;
display a second web page to the end user; and
re-display the first web page based on the at least one update to the object.

9. The data processing system of claim 8, wherein the update to the first web page persists in the object while the second web page is displayed to the end user.

10. The data processing system of claim 8, the data processing system further configured to:
receive a design of the web application from a developer, wherein the design does not include program code to manage the at least one update to the first web page in the object.

11. The data processing system of claim 8, wherein to display the first web page to the end user, the data processing system:
automatically generates HTML code associated with displaying the first web page; and
sends the HTML code to the web browser of the end user.

12. The data processing system of claim 11, wherein the HTML code is automatically generated when the first web page is requested to be displayed by the web browser of the end user.

13. The data processing system of claim 8, wherein to receive at least one update to the first web page, the data processing system:
receives a change to at least one user-updatable control.

14. The data processing system of claim 8, wherein the web application is developed and executed using an integrated development environment.

15. A computer program product for developing and executing a web application, the computer program product comprising a tangible machine-readable medium encoded with computer-executable instructions that when executed cause a data processing system to perform the steps of:
instantiating an object in a memory, the object associated with a first web page of the web application;
displaying the first web page to an end user;
receiving at least one update to the first web page from a web browser of the end user;
storing the at least one update to the first web page in the object;
displaying a second web page to the end user; and
re-displaying the first web page based on the at least one update to the object.

16. The computer program product of claim 15, wherein the update to the first web page persists in the object while the second web page is displayed to the end user.

17. The computer program product of claim 15, the computer program product further configured to cause the data processing system to perform:
receiving a design of the web application from a developer, wherein the design does not include program code to manage the at least one update to the first web page in the object.

18. The computer program product of claim 15, wherein displaying the first web page to the end user comprises:
automatically generating HTML code associated with displaying the first web page; and
sending the HTML code to the web browser of the end user.

19. The computer program product of claim 18, wherein the HTML code is automatically generated when the first web page is requested to be displayed by the web browser of the end user.

20. The computer program product of claim 15, wherein receiving at least one update to the first web page comprises:
receiving a change to at least one user-updatable control.
